(19) United States
(12) Patent Application Publication
(10) Pub. No.: US 2015/0299373 A1
(43) Pub. Date: Oct. 22, 2015

(54) METHOD FOR PRODUCING SOFT POLYURETHANE FOAM BASED ON POLYESTER POLYOLS

(71) Applicant: BAYER MATERIALSCIENCE AG, Monheim Am Rhein (DE)

(72) Inventors: Hartmut NEFZGER, Pulheim (DE); Bert KLESCZEWSKI, Köln (DE); Sven MEYER-AHRENS, Leverkusen (DE); Harald KNAUP, Neuss (DE)

(73) Assignee: BAYER MATERIALSCIENCE AG, Monheim Am Rhein (DE)

(21) Appl. No.: 14/437,870

(22) PCT Filed: Oct. 23, 2013
(86) PCT No.: PCT/EP2013/072117

§ 371 Date: Apr. 23, 2015

(30) Foreign Application Priority Data
Oct. 26, 2012 (EP) 12190080.7

(51) Int. Cl. C08G 18/24; C08G 18/34; C08G 63/16; C08G 18/76

(52) U.S. Cl. CPC C08G 18/248; C08G 18/7657; C08G 18/341; C08G 63/16; C08G 2101/0008

(57) ABSTRACT

The present invention relates to a process for the production of flexible polyurethane foams, wherein there is used as starting material a polyester polyol component which is composed of at least two dicarboxylic acids.

The present invention relates to a process for the production of flexible polyurethane foams, wherein there is used as starting material a polyester polyol component which is composed of at least two dicarboxylic acids.

Polyester polyols are obtained commercially by polycondensation of monomeric dicarboxylic acids, their anhydrides and/or their low molecular weight dialkyl esters and alcohol components.

Within the context of discussions about protecting oil stocks, substituting such materials wholly or partially with renewable raw materials is seen as a possible contribution on the part of the plastics-producing industry. Commercially, structural units from which polyester polyols can be prepared, that is to say aliphatic polycarboxylic acids and aliphatic polyols, are within reach, while the corresponding aromatic polyisocyanates are at present still not obtainable commercially.

Polyester-polyol-based flexible polyurethane foams per se have been known for a long time and are widely described. A whole range of aliphatic and aromatic polycarboxylic acids are disclosed in the prior art for preparing polyester polyols. There may be mentioned by way of example DE 199 09 978 A1, according to which suitable polyester polyols can be prepared by condensation of organic dicarboxylic acids having from 2 to 12 carbon atoms and polyhydric alcohols. Succinic acid, giutaric acid and adipic acid, including mixtures thereof, are preferably used. As regards the polyols, polyhydric alcohols having from 2 to 12 carbon atoms, particularly preferably from the group ethylene glycol to 1,6-hexanediol, and especially diethylene glycol and small amounts of glycerol and/or trimethylolpropane, are used.

EP 0 672 696 A1 discloses a number of carboxylic acids, diols and polyols which are suitable for the preparation of polyester polyols which are ultimately to be used in flexible PUR foam.

U.S. Pat. No. 5,908,871 (col. 3, li, 16), U.S. Pat. No. 4,331,555 (col. 10, li. 6); FR 1 288 300 A (polyesters A and B), DE 195 28 539 A1 (Examples 2-4) and DE 199 49 091 A1 (Examples 1-2) likewise disclose a whole range of starting materials for the synthesis of polyester polyols.

US 2006/0046067 A1 discloses the preparation of polyester polyols which are obtainable by reaction of at least two dicarboxylic acids and at least one di- and/or poly-hydric aliphatic alcohol. However, US 2006/0046067 discloses polyester polyols which comprise more than 5 wt. % aromatic dicarboxylic acids.

EP 0 017 060 A1 discloses a process for the production of polyurethane elastomers by reacting organic polyisocyanates with polyester polyols. However, these polyester polyols have an ester group concentration of more than 9.80 mol/kg.

GB 1 475 541 A and EP 0 044 969 A1 disclose polyester polyols which are used in the production of polyurethane foams based on polyester polyols or in the production of thermoplastically processable polyurethane elastomers. These polyester polyols have an ester group concentration of more than 9.80 mot/kg.

Polyurethane Handbook, 2nd Edition (G. Oertel, Carl Hanser Verlag 1993) gives no further details regarding the selection of the polyester polyols which can be used for the production of flexible polyester foams (see p. 201 and p. 67).

It can be deduced from the mentioned patent specifications that, in polyester-polyol-based flexible polyurethane foams, the number-average molar mass of the polyester polyol should be in the range of approximately from 2000 to 4000 Da and the hydroxyl functionality should be in the range of from 2 to 3. Therefore, all the polyester polyols known hitherto that fall within the mentioned molar mass and hydroxyl functionality range should be suitable for the production of corresponding flexible polyurethane foams. Within the scope of this invention, however, it has been possible to show that not all the possible polyester polyols are suitable for the production of flexible polyurethane foams.

A polyester polyol composed of succinic acid, diethylene glycol and 1,1,1-trimethylolpropane, with a hydroxyl number of 60 mg KOHN and a functionality of 2.7, corresponding to a number-average molar mass of 2525 Da, should therefore be suitable for the production of flexible polyurethane foam. However, this is not the case at all. In fact, the use of such a polyester polyol, in contrast to a polyester polyol that has the same hydroxyl number and functionality but is based on adipic acid, leads to the collapse of the rising foam, the foam formulation otherwise being identical. There are obviously additional demands which must be met by the polyester polyol components if they are to be suitable for use for the production of flexible polyurethane foams.

Accordingly, it was an object of the present invention to provide a process for the production of flexible polyurethane foams which eliminates that deficiency. For ecological reasons in particular, it would be advantageous to use inter alia also polyester polyol components that are based on renewable raw materials.

Surprisingly, it has been found that the above-mentioned object is achieved by a process for the production of polyester-polyol-based flexible polyurethane foams by reaction of component A (polyol formulation) comprising
A1 100 parts by weight of at least one polyester polyol having a hydroxyl number of from 40 mg KOH/g to 85 mg KOH/g, an acid number of less than 5 mg KOH/g and an ester group concentration of less than 9.80 mol/kg, preferably from 2.0 to 9.80 mol/kg and particularly preferably from 6.0 to 9.75 mol/kg, wherein the polyester polyol is obtainable by reaction of
   A1.1 at least two dicarboxylic acids and
   A1.2 at least one di- and/or poly-hydric aliphatic alcohol.
A2 from 0.5 to 25 parts by weight, preferably from 1.5 to 6 parts by weight (based on the parts by weight of component A1), of water and/or physical blowing agents,
A3 from 0.05 to 10 parts by weight, preferably from 0.2 to 4 parts by weight (based on the parts by weight of component A1), of auxiliary substances and additives such as
   a) catalysts,
   b) surface-active additives,
   c) pigments or flame retardants,
A4 from 0 to 10 parts by weight, preferably from 0 to 5 parts by weight (based on the parts by weight of component A1), of compounds containing isocyanate-reactive hydrogen atoms and having a molecular weight of from 62 to 399,
   with component B comprising di- and/or poly-isocyanates,
   wherein the production takes place at an index of from 50 to 250, preferably from 70 to 130, particularly preferably from 75 to 115, and
   wherein all the parts by weight of components A2 to A4 specified in the present application are based on 100 parts by weight of component A1.

The invention further provides the polyester-polyol-based flexible polyurethane foams that are produced by the process according to the invention. These flexible polyurethane foams preferably have a bulk density according to DIN EN ISO 3386-1-98 in the range of from ≧10 kg/m³ to ≦150 kg/m³, preferably from ≧20 kg/m³ to ≦70 kg/m³, and a compressive strength according to DIN EN ISO 3386-1-98 in the range of from ≧0.5 kPa to ≦20 kPa (at 40% deformation and 4th cycle).

The invention further provides also a process for the preparation of polyester polyols A1 having a hydroxyl number of from 40 fig KOH/g to 85 mg KOH/g, an acid number of less than 5 mg KOH/g and an ester group concentration of less than 9.80 mol/kg, preferably from 2.0 to 9.80 mol/kg and particularly preferably from 6.0 to 9.75 mol/kg, wherein the polyester polyol is obtainable by reaction of
A1.1 at least two dicarboxylic acids and
A1.2 at least one di- and/or poly-hydric aliphatic alcohol.

The invention further provides also polyester polyols A1 having a hydroxyl number of from 40 mg KOH/g to 85 mg KOH/g, an acid number of less than 5 mg KOH/g and an ester group concentration of less than 9.80 mol/kg, preferably from 2.0 to 9.80 mol/kg, particularly preferably from 6.0 to 9.75 mol/kg.

### Component A1

The polyester polyols used according to the invention are obtainable by polycondensation of at least two dicarboxylic acids (A1.1) and at least one di- and/or poly-hydric aliphatic alcohol (A1.2), wherein the polycondensation can be carried out at least partially in the presence of a catalyst.

Component A1 preferably comprises a polyester which is an aliphatic polyester to the extent of at least 95 wt. % and the component A1.2 of which is selected to the extent of at least 90 wt. % from the group consisting of ethylene glycol, diethylene glycol and/or trimethylolpropane.

The polyester polyols used have an acid number of less than 5 mg KOH/g, preferably of less than 4 mg KOH/g. This can be achieved by terminating the polycondensation when the acid number of the reaction product obtained is less than 5 mg KOH/g, preferably less than 4 mg KOH/g. The polyester polyols used have a hydroxyl number of from 40 mg KOH/g to 85 mg KOH/g, preferably from 45 to 75 mg KOH/g, and a functionality of from 2 to 6, preferably from 2 to 3, particularly preferably from 2.2 to 2.8. The ester group concentration of the polyester polyols used is less than 9.80 mol/kg, preferably from 2.0 to 9.80 mol/kg and particularly preferably from 6.0 to 9.75 mol/kg.

The ester group concentration (polarity) is calculated directly from the formulation by first determining the size of the batch in [g], that is to say the sum in [g] of all the acid components and alcohol components used is formed. The water of reaction obtained arithmetically in the case of complete conversion of all the carboxyl groups is then subtracted from that sum (number of carboxyl groups×number of moles of the carboxylic acid used [mol]×molar weight of water (=18 g/mol)). The carboxyl groups of the acid used that have been converted into ester groups are normalised to one kilogram of polyester. This gives the following formula (I):

Ester group conc. [mol/kg]=moles of COOH groups converted into ester groups [mol]/(size of the

batch [g]−amount of water of reaction in the case of complete conversion [g])×1000 (I)

The functionality of the polyester component is likewise obtained from the formulation according to formula (H):

Functionality of the polyester component=number of OH end groups/number of molecules (II)

The number of molecules is obtained by subtracting the moles of ester groups formed from the sum of the moles of all the substances used. If only polycarboxylic acids are used, the number of moles of ester groups formed corresponds to the number of moles of water of reaction formed. In the case of carboxylic anhydrides, correspondingly less water is formed; when low molecular weight alkyl esters are used, low molecular weight alcohol forms instead of the water.

The number of OH end groups is obtained by subtracting the moles of carboxyl groups converted into ester groups from the moles of OH groups used.

Component A1.1 comprises at least two organic dicarboxylic acids having from to 12, preferably from 2 to 10, carbon atoms between the carboxyl groups. Suitable dicarboxylic acids are, for example, succinic acid, glutaric acid, adipic acid, pimelic acid, suberic acid, azelaic acid, sebacic acid, undecanedioic acid, dodecanedioie acid, tridecanedioic acid and/or tetradecanedinic acid or their anhydrides and/or their low molecular weight dialkyl esters. Preference is given to succinic acid, glutaric acid, adipic acid, pimelic acid, suberic acid, azelaic acid and/or sebacic acid, and particular preference is given to succinic acid, adipic acid, azelaic acid and sebacic acid. Component A1.1 can comprise at least one dicarboxylic acid that is prepared by a fermentative process or is of biological origin.

In addition to the mentioned aliphatic dicarboxylic acids, an amount of up to 10 wt. %, based on A1.1, of aromatic dicarboxylic acid, such as, for example, phthalic acid, phthalic anhydride, isophthalic acid, terephthalic acid and/or their dialkyl esters, can be used.

Component A1.2 comprises di- and/or poly-hydric aliphatic alcohols and/or polyether alcohols having a molecular mass of from 62 g/mol to 400 g/mol. These include, for example, 1,4-dihydroxycyclohexane, 1,2-propanediol, 1,3-propanediol, 2-methyl-1,3-propanediol, 1,5-pentanediol, 1,6-hexanediol, 1,8-octanediol, neopentyl glycol, ethylene glycol, diethylene glycol, triethylene glycol, tetraethylene glycol, dipropylene glycol, tripropylene glycol, dibutylene glycol, tripropylene glycol, glycerol, pentaerythritol and/or trimethylolpropane. Preference is given to neopentyl glycol, diethylene glycol, triethylene glycol, trimethylolpropane and/or glycerol, and particular preference is given to ethylene glycol, diethylene glycol and/or trimethylolpropane. Component A1.2 can comprise at least one alcohol that is prepared by a fermentative process or is of biological origin.

The mentioned alcohols have boiling points at which discharge together with water of reaction can be avoided and also do not have a tendency to undesirable secondary reactions at the conventional reaction temperatures.

The polycondensation can be performed with or without suitable catalysts which are known to the person skilled in the art.

The ester condensation reaction can be carried out at reduced pressure and elevated temperature with the simultaneous removal by distillation of the water, or low molecular weight alcohol, formed in the condensation reaction. It can likewise take place by the azeotropic process in the presence of an organic solvent such as toluene as entrainer or by the carrier gas process, that is to say by expulsion of the water that forms with an inert gas such as nitrogen or carbon dioxide.

The reaction temperature in the polycondensation is preferably from ≧150° C. to ≦250° C. The temperature can also be in a range of from ≧180° C. to ≦230° C.

### Component A2

Water and/or physical blowing agents are used as component A2. Carbon dioxide and/or readily volatile organic substances, for example, are used as physical blowing agents.

### Component A3

There are used as component A3 auxiliary substances and additives such as
a) catalysts (activators),
b) surface-active additives (surfactants), such as emulsifiers and foam stabilisers, in particular those with low emission such as, for example, products of the Tegostab® LF series,
c) additives such as reaction retarders (e.g. acid-reacting substances such as hydrochloric acid or organic acid halides), cell regulators (such as, for example, paraffins or fatty alcohols or dimethylpolysiloxanes), pigments, colourants, flame retardants (such as, for example, tricresyl phosphate or ammonium polyphosphate), stabilisers against ageing and weathering influences, plasticisers, substances having a fungistatic and bacteriostatic action, fillers (such as, for example, barium sulfate, kieselguhr, black chalk or prepared chalk) and release agents.

These auxiliary substances and additives which are optionally to be used concomitantly are described, for example, in EP-A 0 000 389, pages 18-21. Further examples of auxiliary substances and additives which are optionally to be used concomitantly according to the invention, and details of the use and mode of action of these auxiliary substances and additives, are described in Kunststoff-Handbuch, Volume VII, published by Oertel, Carl-Hanser-Verlag, Munich, 3rd Edition, 1993, for example on pages 104-127.

There are preferably used as catalysts aliphatic tertiary amines (for example trimethylamine, tetramethylbutanediamine), cycloaliphatic tertiary amines (for example 1,4-diaza(2,2,2)bicyclooctarte), aliphatic amino ethers (for example dimethylaminoethyl ether and N,N,N-trimethyl-N-hydroxyethyl-bisaminoethyl ether), cycloaliphatic amino ethers (for example N-ethylmorpholine), aliphatic amidines, cycloaliphatic amidines, urea, derivatives of urea (such as, for example, aminoalkylureas, see, for example, EP-A 0 176 013, in particular (3-dimethylaminopropylamine)-urea) and tin catalysts (such as, for example, dibutyltin oxide, dibutyltin dilaurate, tin octoate).

There are particularly preferably used as catalysts
α) urea, derivatives of urea and/or
β) amines and amino ethers which in each case contain a functional group which reacts chemically with the isocyanate. The functional group is preferably a hydroxyl group, a primary or secondary amino group. These particularly preferred catalysts have the advantage that they exhibit greatly reduced migration and emission behaviour.

There may be mentioned as examples of particularly preferred catalysts: (3-dimethylaminopropylamine)-urea, 2-(2-dimethylaminoethoxyl)ethanol, N,N-bis(3-dimethyl-aminopropyl)-N-isopropanolamine, N,N,N-trimethyl-N-hydroxyethyl-bisaminoethyl ether and 3-dimethylaminopropylamine.

### Component A4

There are optionally used as component A4 compounds having at least two isocyanate-reactive hydrogen atoms and a molecular weight of from 32 to 399. These are to be understood as meaning compounds containing hydroxyl groups and/or amino groups and/or thiol groups and/or carboxyl groups, preferably compounds containing hydroxyl groups and/or amino groups, which serve as chain extenders or crosslinkers. These compounds generally contain from 2 to 8, preferably from 2 to 4, isocyanate-reactive hydrogen atoms. For example, there can be used as component A4 ethanolamine, diethanolamine, triethanolamine, sorbitol and/or glycerol. Further examples of compounds according to component A4 are described in EP-A 0 007 502, pages 16-17.

### Component B

Suitable di- and/or poly-isocyanates are aliphatic, cycloaliphatic, araliphatic, aromatic and heterocyclic polyisocyanates, as are described, for example, by W. Siefken in Justus Liebigs Annalen der Chemie, 562, pages 75 to 136, for example those of formula (III)

Q(NCO)ₙ, (III)

wherein
n from 2 to 4, preferably from 2 to 3,
and
Q represents an aliphatic hydrocarbon radical having from 2 to 18, preferably from 6 to 10, carbon atoms, a cycloaliphatic hydrocarbon radical having from 4 to 15, preferably from 6 to 13, carbon atoms, or an araliphatic hydrocarbon radical having from 8 to 15, preferably from 8 to 13, carbon atoms.

For example, they are polyisocyanates as are described in EP-A 0 007 502, pages 7-8. Preference is generally given to the polyisocyanates that are readily obtainable commercially, for example 2.4- and 2,6-toluene diisocyanate, as well as arbitrary mixtures of those isomers (“TDI”); polyphenylpolymethylene polyisocyanates, as are prepared by aniline-formaldehyde condensation and subsequent phosgenation (“crude MDI”), and polyisocyanates containing carbodiimide groups, urethane groups, allophanate groups, isocyanurate groups, urea groups or biuret groups (“modified polyisocyanates”), in particular those modified polyisocyanates which are derived from 2,4- and/or 2,6-toluene diisocyanate or from 4,4′- and/or 2,4′-diphenylmethane diisocyanate. There is preferably used as the polyisocyanate at least one compound selected from the group consisting of 2,4- and 2,6-toluene diisocyanate, 4,4′- and 2,4′- and 2,2′-diphenylmethane diisocyanate and polyphenylpolymethylene polyisocyanate (“polynuclear MDI”); mixtures of 2,4- and 2,6-toluene diisocyanate are particularly preferably used as the polyisocyanate.

For the production of the flexible polyurethane foams, the reaction components are reacted according to the one-stage process known per se, mechanical equipment, for example that described in EP-A 355 000, often being used Details of processing equipment which is also suitable according to the invention are described in Kunststoff-Handbuch, Volume VII, published by Vieweg and Höchtlen, Carl-Hansen-Verlag, Munich 1993, for example on pages 139 to 265.

The flexible polyurethane foams can be produced as moulded foams or as slabstock foams. The invention accordingly provides a process for the production of flexible polyurethane foams, flexible polyurethane foams produced by this process, flexible polyurethane slabstock foams or flexible polyurethane moulded foams produced by this process, the use of the flexible polyurethane foams in the production of mouldings, and also the mouldings themselves. The flexible polyurethane foams obtainable according to the invention have the following uses, for example: furniture upholstery, textile inlays, mattresses, motor vehicle seats, headrests, armrests, sponges and structural elements.

The index gives the ratio in percent of the amount of isocyanate actually used to the stoichiometric amount of isocyanate groups (NCO), that is to say the calculated amount for the conversion of the OH equivalents.

Index=[(amount of isocyanate used):(calculated amount of isocyanate)]·100 (IV)

Flexible polyurethane foams within the meaning of the present invention are flexible polyurethane foams whose bulk density according to DIN EN ISO 3386-1-98 is in the range of from ≧10 kg/m³ to ≦150 kg/m³, preferably in the range of from ≧20 kg/m³ to ≦70 kg/m³, and whose compressive strength according to DIN EN ISO 3386-1-98 is in the range of from ≧0.5 kPa to ≦20 kPa (at 40% deformation and in the 4th cycle).

### EXAMPLES

The present invention is explained further by means of the following examples. In the examples, the materials and abbreviations used have the following meanings and sources:
Adipic acid: from BASF SE, Germany
Succinic acid: bio-based succinic acid from Reverdia (Joint Venture DSM and Roquette), Netherlands
Sebacic acid: sebacic acid JHG, from Jinghua, China
Azelaic acid: Emerox® 1101 from Emery Oleochemicals GmbH, Germany
Glutaric anhydride: from Acros Germany
Monoethylene glycol: from INEOS GmbH, Germany
Diethylene glycol: from INEOS GmbH, Germany
Trimethylolpropane: from Lanxess AG, Germany
Tin(II) chloride dihydrate: from Aldrich, Germany
B1: toluene diisocyanate having a content of about 80 wt. % 2,4-toluene diisocyanate and about 20 wt. % 2,6-toluene diisocyanate from Bayer MaterialScience AG, Germany
B2: toluene diisocyanante having a content of about 65 wt. % 2,4-toluene diisocyanate and about 35 wt. % 2,6-toluene diisocyanate from Bayer MaterialScience AG, Germany
A3-1: Silbyk® 9100: polyether-modified polysiloxane, foam stabiliser, BYK Chemie
A3-2: Tegostab® B 2370: polysiloxane-poiyoxyalkylene block copolymer; foam stabiliser, Cioldschmidt
A3-3: Tegostab® B 8324: polysiloxane-polyoxyalkylene block copolymer; foam stabiliser, Goldschmidt
A3-4: catalyst: mixture of 15 parts by weight RCA® 117 (N,N′-dimethylpiperazine) from Rheinchemie GmbH, 15 parts by weight Niax® A30 from Momentive Performance Materials Inc. and 70 parts by weight of a linear polyether polyol with an OH number of 56 mg KOH/g and about 60 mol % primary OH end groups.

The analyses were carried out as follows:
Dynamic viscosity: MCR 51 rheometer from Anton Paar in accordance with DIN 53019.
Hydroxyl number (OH number) was determined in accordance with DIN 53240.
Acid number was determined in accordance with DIN 53402.
The bulk density was determined in accordance with DIN EN ISO 3386-1-98.
The compressive strength was determined in accordance with DIN EN ISO 3386-1-98 (at 40% deformation in the 1st and 4th cycle).
The compression set DVR 50% (Ct) was determined in accordance with DIN EN ISO 1856-2001-03.
The tensile strength and elongation at break were determined in accordance with DIN EN ISO 1798.

### Preparation of the Polyester Polyols A1 Using A1-1(C)—Comparison—as an Example:

5111.6 g of adipic acid (35 mol, corresponds to 55.2 wt. %), 3810 g (35.9 mol, corresponds to 41.15 wt. %) of diethylene glycol and 337.7 g (2.52 mol, corresponds to 3.65 wt. %) of 1,1,1-trimethylolpropane were placed in a 10-litre four-necked flask equipped with a mechanical stirrer, a 50 cm Vigreux column, a thermometer, androgen inlet, and also a column head, a distillation bridge and a vacuum membrane pump, and the mixture was heated in the course of 60 minutes to 200° C., with nitrogen blanketing, water of reaction being removed by distillation. After 8 hours, 160 mg of tin dichloride dihydrate (corresponds to 20 ppm, based on the end product) were added and the reaction was continued. After a total reaction time of 15 hours, the pressure was slowly reduced to 15 mbar in the course of 5 hours. During the further reaction, the acid number was monitored: After a total reaction time of 35 hours, the acid number was 1.25 mg KOH/g.

### Analysis of Polyester A1-1 (C):

Hydroxyl number: 60.0 mg KOH/g, theoret. 66 mg KOH/g
Acid number: 1.25 mg KOH/g
Viscosity: 1280 mPas (75° C.)

The ester group concentration was calculated directly from the formulation by first determining the size of the batch (5111.6 g+3810 g+337.7 g=9259.3 g), subtracting therefrom the water of reaction obtained mathematically in the case of complete conversion of all the carboxyl groups (2×35 mol×18 g/mol=1260 g) and normalising the carboxyl groups of the adipic acid that have been converted into ester groups to one kilo of polyester:

Ester group concentration=

2×35 mol/(9259.3 g−1260 g)×1000=8.8 mol of ester groups/kg of polyester A1-1(C)

TABLE 1
Formulations of polyester polyols A1 - prior art (A1-
1(C) and comparison examples (A1-2(C) to A1-4(C))

| | | A1-1(C) | A1-2(C) | A1-3(C) | A1-4(C) |
|---|---|---|---|---|---|
| Adipic acid | [wt. %] | 55.46 | | | |
| Succinic acid | [wt. %] | | 50.27 | 49.53 | 49.93 |
| Diethylene glycol | [wt. %] | 41.23 | 46.31 | 45.85 | 47.96 |
| Trimethylolpropane | [wt. %] | 3.31 | 3.42 | 4.62 | 2.11 |
| - Water of reaction | [wt. %] | 13.66 | 15.33 | 15.1 | 15.22 |
| Tin(II) | [ppm] | 20 | 20 | 20 | 20 |
| chloride*2H₂O | | | | | |
| Properties: | | | | | |
| OH number | [mg KOH/g] | 60 | 60.6 | 82.4 | 66.0 |
| Acid number | [mg KOH/g] | 1.25 | 0.6 | 0.96 | 0.18 |
| Functionality | | 2.73 | 2.7 | 2.73 | 2.35 |
| Ester group | [mol/kg] | 8.8 | 10.1 | 9.9 | 10.0 |
| concentration | | | | | |
| Viscosity 75° C. | [mPas] | 1280 | 2570 | 1360 | 1360 |

(C)means comparison

Polyesters A1-1(C) to A1-4(C) are synthesised using a single dicarboxylic acid. Only comparison example A1-1(C) shows an ester group concentration that is within the range according to the claims. A1-2(C) to A1-4(C) show ester group concentrations of 9.9 mol/kg and above, that is to say they are outside the range according to the invention.

Production of Flexible Polyurethane Slabstock Foams Using the Polyester Polyols from Table 1

The substances listed in the examples in Table 2 below are reacted with one another according to the one-stage process in the manner of processing that is conventional for the production of polyurethane foams.

TABLE 2
Formulations for the production of flexible polyurethane slabstock foams using the
polyester polyols from Table 1

| Example | | 1(C) | 2(C) | 2A(C) | 3(C) | 4(C) | 4A(C) |
|---|---|---|---|---|---|---|---|
| A1-1(C) | [Pts.] | 100 | | | | | |
| A1-2(C) | [Pts.] | | 100 | 100 | | | |
| A1-3(C) | [Pts.] | | | | 100 | | |
| A1-4(C) | [Pts.] | | | | | 100 | 100 |
| Water (added) | [Pts.] | 3.00 | 3.00 | 3.00 | 3.00 | 3.00 | 3.00 |
| A3-1 | [Pts.] | | 1.00 | | 1.00 | 1.00 | 1.00 |
| A3-2 | [Pts.] | | | 1.00 | | | |
| A3-3 | [Pts.] | 1.00 | | | | | |
| A3-4 | [Pts.] | 1.70 | 1.70 | 1.70 | 1.70 | 1.70 | 1.70 |
| Total | [Pts.] | 105.70 | 105.7 | 105.7 | 105.7 | 105.7 | 105.7 |
| B1 | [Pts.] | 19.20 | 19.20 | 19.20 | 20.62 | 19.69 | 19.69 |
| B2 | [Pts.] | 19.20 | 19.20 | 19.20 | 20.62 | 19.69 | 19.69 |
| Total | [Pts.] | 38.41 | 38.40 | 38.40 | 41.24 | 39.38 | 39.38 |
| Index | | 100 | 100 | 100 | 100 | 100 | 100 |
| Start time | [s] | 15 | 15 | 20 | | 20 | 15 |
| Rise time | [s] | 83 | 15 | 15 | | 40 | 35 |
| Test data | | | | | | | |
| Bulk density | [kg/m³] | 39 | | | | | |
| Compressive strength 40%, 1st | [kPa] | 11.67 | | | | | |
| Compressive strength 40%, 4th | [kPa] | 6 46 | | | | | |
| DVR 50% | [%] | 3.0 | | | | | |
| Tensile strength | [kPa] | 143 | | | | | |
| Elongation at break | [%] | 179 | | | | | |

(C) means comparison; [Pts.] means parts; compressive strength 40%, 1st means compressive strength 40%, measured after the 1st cycle; compressive strength 40%, 4th means compressive strength 40%, measured after the 4th cycle.

Flexible polyurethane slabstock foams (2(C) to 4A(C)) could not be produced from polyester polyols A1-2(C) to A1-4(C) because they collapsed on foaming. It was only possible to produce a flexible polyurethane slabstock foam with polyester polyol A1-1(C), which is based on a single dicarboxylic acid and is therefore outside the range according to the invention.

TABLE 3
Formulations of polyester polyols A1, produced using two dicarboxylic acids.

| | | A1-5 | A1-6 | A1-7 | A1-8 | A1-9 | A1-10 | A1-11 | A1-12 | A1-13 | A1-14 | A1-15(C) | A1-16(C) |
|---|---|---|---|---|---|---|---|---|---|---|---|---|---|
| Adipic acid | [wt. %] | | | | | | | | | | 21.57 | | |
| Sebacic acid | [wt. %] | | 24.01 | 10.37 | 17.12 | 24.0 | 11.17 | 33.28 | 24.0 | 33.28 | | | |
| Succinic acid | [wt. %] | 41.68 | 30.83 | 41.42 | 36.17 | 30.84 | 40.95 | 28.04 | 30.84 | 28.04 | 30.04 | 37.39 | 25.02 |
| Azelaic acid | [wt. %] | 10.00 | | | | | | | | | | | |
| Glutaric | [wt. %] | | | | | | | | | | | 15.33 | 27.99 |
| anhydride | | | | | | | | | | | | | |
| Diethylene | [wt. %] | 46.41 | 41.40 | 45.96 | 43.79 | 43.19 | 43.83 | 22.98 | 43.19 | 22.98 | 45.76 | 40.59 | 41.21 |
| glycol | | | | | | | | | | | | | |
| Trimethylol- | [wt. %] | 2.13 | 3.75 | 2.25 | 2.92 | 1.97 | 4.05 | 2.25 | 1.97 | 2.25 | 2.63 | 1.92 | 1.93 |
| propane | | | | | | | | | | | | | |
| Monoethylene | [wt. %] | | | | | | | 13.44 | | 13.44 | | 4.76 | 3.85 |
| glycol | | | | | | | | | | | | | |
| Water of | [wt. %] | 14.69 | 13.67 | 14.47 | 14.07 | 13.67 | 14.47 | 14.47 | 13.67 | 14.47 | 14.47 | 15.58 | 15.25 |
| reaction | | | | | | | | | | | | | |
| Tin(II) | [ppm] | 20 | 20 | 20 | 20 | 20 | 20 | 20 | 20 | 20 | 20 | 20 | 20 |
| chloride*2H₂O | | | | | | | | | | | | | |
| OH number | [mg KOH/g] | 66.7 | 65.6 | 71.5 | 67.5 | 62.0 | 70.8 | 61.7 | 61.2 | 69.6 | 73.0 | 58.8 | 58.9 |
| Acid number | [mg KOH/g] | 0.43 | 0.69 | 0.23 | 0.19 | 0.82 | 0.78 | 0.61 | 0.50 | 0.26 | 1.72 | 0.95 | 0.44 |
| Functionality | | 2.35 | 2.73 | 2.35 | 2.5 | 2.4 | 2.73 | 2.35 | 2.35 | 2.35 | 2.4 | 2.35 | 2.35 |
| Ester group | [mol/kg] | 9.57 | 8.8 | 9.4 | 9.1 | 8.8 | 9.45 | 9.4 | 8.8 | 9.4 | 9.4 | 10.25 | 10 |
| concentration | | | | | | | | | | | | | |
| Viscosity 75° C. | [mPa * s] | 1130 | 1620 | 940 | 1110 | 980 | 1600 | 1170 | 1060 | 910 | 860 | 1290 | 1130 |

(C) means comparison;
The preparation of polyester polyols A1-5 to A1-16 according to Table 3 took place analogously to the preparation procedure for polyester polyol A1-1(C).

TABLE 4
Formulations for the production of flexible polyurethane
slabstock foams using the polyester polyols from Table 3.

| Example | | 5 | 6 | 7 | 8 | 9 | 10 | 10A | 11 | 12 | 13 | 14 | 15(C) | 16(C) |
|---|---|---|---|---|---|---|---|---|---|---|---|---|---|---|
| A1-5 | [Pts.] | 100 | | | | | | | | | | | | |
| A1 | [Pts.] | | 100 | | | | | | | | | | | |
| A1-7 | [Pts.] | | | 100 | | | | | | | | | | |
| A1-8 | [Pts.] | | | | 100 | | | | | | | | | |
| A1-9 | [Pts.] | | | | | 100 | | | | | | | | |
| A1-10 | [Pts.] | | | | | | 100 | 100 | | | | | | |
| A1-11 | [Pts.] | | | | | | | | 100 | | | | | |
| A1-12 | [Pts.] | | | | | | | | | 100.09 | | | | |
| A1-13 | [Pts.] | | | | | | | | | | 100 | | | |
| A1-14 | [Pts.] | | | | | | | | | | | 100 | | |
| A1-15(C) | [Pts.] | | | | | | | | | | | | 100 | |
| A1-16 (C) | [Pts.] | | | | | | | | | | | | | 100 |
| Water (added) | [Pts.] | 3.00 | 3.00 | 3.00 | 3.00 | 3.00 | 3.00 | 3.00 | 3.00 | 3.00 | 3.00 | 3.00 | 3.00 | 3.00 |
| A-3-1 | [Pts.] | 1.00 | 1.00 | 1.00 | 1.00 | | | | | | | | | |
| A-3-3 | [Pts.] | | | | | 1.00 | 1.00 | 1.00 | 1.00 | 1.00 | 1.00 | 1.00 | 1.00 | 1.00 |
| A3-4 | [Pts.] | 1.70 | 1.70 | 1.70 | 1.70 | 1.70 | 1.70 | 1.70 | 1.70 | 1.70 | 1.70 | 1.70 | 1.70 | 1.70 |
| Total | [Pts.] | 105.7 | 105.70 | 105.70 | 105.70 | 105.70 | 105.70 | 105.70 | 105.70 | 105.79 | 105.70 | 105.7 | 105.70 | 105.70 |
| B1 | [Pts.] | 19.75 | 19.71 | 20.17 | 19.81 | 19.36 | 20.11 | | 19.34 | 19.31 | 20.02 | 20.21 | 18.73 | 19.19 |
| B2 | [Pts.] | 19.75 | 19.71 | 20.17 | 19.81 | 19.36 | 20.11 | 39.99 | 19.34 | 19.31 | 20.02 | 20.21 | 18.73 | 19.19 |
| Total | [Pts.] | 39.49 | 39.42 | 40.33 | 39.62 | 38.72 | 40.23 | 39.99 | 38.67 | 38.63 | 40.04 | 40.41 | 37.47 | 38.37 |
| Index | | 100 | 100 | 100 | 100 | 100 | 100 | 100 | 100 | 100 | 100 | 100 | 100 | 100 |
| Start time | [s] | 10 | 15 | 13 | 13 | 14 | 15 | 15 | 15 | 13 | 15 | 15 | 17 | 14 |
| Rise time | [s] | 70 | 75 | 73 | 75 | 80 | 75 | 70 | 82 | 81 | 80 | 90 | 45 | 50 |
| Test data | | | | | | | | | | | | | | |
| Bulk density | [kg/m³] | | 34.2 | 34.6 | 37 | 38 | 33.5 | 35 | 38 | 37 | 34.67 | 36 | | |
| Compressive | [kPa] | | 11.06 | 9.57 | | 11.43 | 10.85 | 14.78 | 12.61 | 7.79 | 9.44 | 9.22 | | |
| strength | | | | | | | | | | | | | | |
| 40% 1st | | | | | | | | | | | | | | |
| Compressive | [kPa] | | 6.26 | 5.58 | 5.35 | 6.17 | 6.21 | 8.44 | 6.96 | 4.87 | 5.41 | 4.91 | | |
| strength | | | | | | | | | | | | | | |
| 40% 4th | | | | | | | | | | | | | | |
| DVR 50% | [%] | | 4.4 | 7.9 | | 3.3 | 5.3 | 5.4 | 3.6 | | 7.8 | | | |
| Tensile strength | [kPa] | | 135 | 157 | | 166 | 129 | 167 | 154 | | 185 | | | |
| Elongation at | [%] | | 158 | 182 | | 244 | 134 | 128 | 219 | | 239 | | | |
| break | | | | | | | | | | | | | | |

Abbreviations: (C) = comparison example; Pts. = parts by weight; compressive strength 40%, 1st means compressive strength 40%, measured after the 1st cycle; compressive strength 40%, 4th means compressive strength 40%, measured after the 4th cycle;

TABLE 5
Formulations of polyester polyols A1, prepared using three dicarboxylic acids.

| | | A1-17 | A1-18 | A1-19 | A1-20 | A1-21(C) | A1-22(C) |
|---|---|---|---|---|---|---|---|
| Sebacic acid | [wt. %] | 8.50 | 4.03 | 6.21 | 9.13 | | |
| Succinic acid | [wt. %] | 12.74 | 44.27 | 41.08 | 36.81 | 21.89 | 17.03 |
| Adipic acid | [wt. %] | 33.59 | 2.91 | 4.49 | 6.60 | 7.74 | 21.08 |
| Glutaric anhydride | [wt. %] | | | | | 24.49 | 19.05 |
| Diethylene glycol | [wt. %] | 43.19 | 46.85 | 46.28 | 45.51 | 38.52 | 29.89 |
| Trimethylolpropane | [wt. %] | 1.97 | 1.94 | 1.94 | 1.95 | 1.93 | 1.92 |
| Monoethylene glycol | [wt. %] | | | | | 5.42 | 11.02 |
| Water of reaction | [wt. %] | −13.67 | −14.93 | −14.73 | −14.47 | −15.25 | −15.58 |
| Tin(II) chloride*2H₂O | [ppm] | 20 | 20 | 20 | 20 | 20 | 20 |
| OH number exp | [mg KOH/g] | 61.0 | 57.8 | 58.2 | 62.1 | 65.0 | 59.8 |
| Acid number (exp.) | [mg KOH/g] | 0.58 | 0.72 | 1.0 | 0.88 | 0.34 | 0.47 |
| Functionality | | 2.35 | 2.35 | 2.35 | 2.35 | 2.35 | 2.35 |
| Ester group concentration | [mol/kg] | 8.8 | 9.75 | 9.6 | 9.4 | 10 | 10.25 |
| Viscosity 75° C. | [mPa * s] | 880 | 1550 | 1230 | 1140 | 840 | 1030 |

(C) means comparison

TABLE 6
Formulations for the production of flexible polyurethane
slabstock foams using the polyester polyols from Table 5.

| | | Prior art | 17 | 18 | 19 | 20 | 21(C) | 22(C) |
|---|---|---|---|---|---|---|---|---|
| A1-1(C) | [Pts.] | 100 | | | | | | |
| A1-17 | [Pts.] | | 100 | | | | | |
| A1-18 | [Pts.] | | | 100 | | | | |
| A1-19 | [Pts.] | | | | 100 | | | |
| A1-20 | [Pts.] | | | | | 100 | | |
| A1-21(C) | [Pts.] | | | | | | 100 | |
| A1-22(C) | [Pts.] | | | | | | | 100 |
| Water (added) | [Pts.] | 3.00 | 3.00 | 3.00 | 3.00 | 3.00 | 3.00 | 3.00 |
| A3-1 | [Pts.] | | | | | | | |
| A3-3 | [Pts.] | 1 | 1 | 1 | 1 | 1 | 1.00 | 1.00 |
| A3-4 | [Pts.] | 1.70 | 1.70 | 1.70 | 1.70 | 1.70 | 1.70 | 1.70 |
| Total | [Pts.] | 105.7 | 105.7 | 105.7 | 105.7 | 105.7 | | |
| B1 | [Pts.] | 19.27 | 19.90 | 19.10 | 19.13 | 19.44 | 19.66 | 19.00 |
| B2 | [Pts.] | 19.27 | 19.90 | 19.10 | 19.13 | 19.44 | 19.66 | 19.00 |
| Total | [Pts.] | 38.55 | 39.81 | 38.21 | 38.27 | 38.87 | 39.32 | 38.00 |
| Index | | 100 | 100 | 100 | 100 | 100 | 100 | 100 |
| Start time | [s] | 15 | 14 | 13 | 18 | 14 | 14 | 14 |
| Rise data | [s] | 80 | 77 | 75 | 92 | 83 | 65 | 73 |
| Test data | | | | | | | | |
| Bulk density | [kg/m³] | 37.4 | 37 | 36.8 | 38.4 | 37.6 | | |
| Compressive strength 40%, 1st | [kPa] | 12.13 | 10.37 | 10.66 | 11.85 | 10.77 | | |
| Compressive strength 40%, 4th | [kPa] | 6.64 | 5.91 | 5.86 | 6.48 | 5.93 | | |
| DVR 50% | [%] | 2.3 | 3.1 | 3.2 | 3 | 5.7 | | |
| Tensile strength | [kPa] | 103 | 112 | 134 | 108 | 129 | | |
| Elongation at break | [%] | 147 | 169 | 214 | 170 | 181 | | |

Abbreviations: (C) = comparison example; Pts. = parts by weight; compressive strength 40%, 1st means compressive strength 40%, measured after the 1st cycle; compressive strength 40%, 4th means compressive strength 40%, measured after the 4th cycle;

The flexible polyurethane slabstock foams of Examples 5 to 14 according to Table 4 have a fine cell structure in the pores. Comparison tests 15(C) and 16(C), which were produced using polyester polyols having an ester group concentration outside the range according to the invention, did not provide flexible polyurethane slabstock foams because they collapsed during production.

The flexible polyurethane slabstock foams of Examples 17 to 20 according to Table 6 have a fine cell structure in the pores. Comparison test 21(C) produced a flexible polyurethane slabstock foam which had an inhomogeneous cell structure, and comparison test 22(C) produced a flexible polyurethane slabstock foam which is torn. Comparison examples 21(C) and 22(C) were produced using polyester polyols having an ester group concentration outside the range according to the invention.

1.-13. (canceled)

14. A process for the production of polyester-polyol-based flexible polyurethane foams comprising reacting component A comprising
A1 100 parts by weight of at least one polyester polyol having a hydroxyl number of from 40 mg KOH/g to 85 mg KOH/g, an acid number of less than 5 mg KOH/g and an ester group concentration of less than 9.80 mol/kg, wherein the polyester polyol is obtained by reaction of
A1.1 at least two dicarboxylic acids and
A1.2 at least one di- and/or poly-hydric aliphatic alcohol,
A2 from 0.5 to 25 parts by weight (based on the parts by weight of component A1) of water and/or physical blowing agents,
A3 from 0.05 to 10 parts by weight (based on the parts by weight of component A1) of auxiliary substances and additives such as
a) catalysts,
b) surface-active additives,
c) pigments or flame retardants,
A4 from 0 to 10 parts by weight (based on the parts by weight of component A1) of compounds containing isocyanate-reactive hydrogen atoms and having a molecular weight of from 62 to 399,
with component B comprising di- and/or poly-isocyanates,
wherein the production takes place at an index of from 50 to 250, and
wherein all the parts by weight of components A2 to A4 specified in the present application are based on 100 parts by weight of component A1.

15. The process according to claim 14, wherein component A1 comprises at least 95 wt. % of an aliphatic polyester.

16. The process according to claim 14, wherein component A1.1 are at least two compounds selected from the group consisting of succinic acid, glutaric acid, adipic acid, pimelic acid, suberic acid, azelaic acid and/or sebacic acid.

17. The process according to claim 14, wherein component A1.2 is, to the extent of at least 90 wt. %, selected from the group consisting of ethylene glycol, diethylene glycol and/or trimethylolpropane.

18. The process according to claim 14, wherein at least one of components A1.1 and/or A1.2 is prepared by a fermentative process and/or is of biological origin.

19. The process according to claim 14, wherein component A1.1 is fermentatively prepared succinic acid and/or bio-based sebacic acid and/or bio-based azelaic acid.

20. The process according to claim 14, wherein the production takes place at an index of from 75 to 115.

21. The process according to claim 14, wherein component B is at least one compound selected from the group consisting of 2,4-toluene diisocyanate, 2,6-toluene diisocyanate, 4,4′-diphenylmethane diisocyanate, 2,4′-diphenylmethane diisocyanate, 2,2′-diphenylmethane diisocyanate and polyphenylpolymethylene polyisocyanate.

22. A flexible polyurethane foam obtained by the process according to claim 14.

23. A process for the preparation of polyester polyol A1 having a hydroxyl number of from 40 mg KOH/g to 85 mg KOH/g, an acid number of less than 5 mg KOH/g and an ester group concentration of less than 9.80 mol/kg, wherein the polyester polyol is obtained by reaction of
A1.1 at least two dicarboxylic acids and
A1.2 at least one di- and/or poly-hydric aliphatic alcohol,
and wherein the polyester polyol is an aliphatic polyester to the extent of at least 95 wt. %.

24. The polyester polyol A1 obtained by the process according to claim 23.

25. A method comprising utilizing the polyester polyols A1 according to claim 24 in the production of flexible polyurethane foams.

26. A method comprising utilizing the flexible polyurethane foams according to claim 22 in the production of furniture upholstery, a mattress, a motor vehicle seat, a headrest, an armrest, a sponge, a textile inlay or a structural element.
